(19) United States
(12) Patent Application Publication
(10) Pub. No.: US 2011/0303161 A1
(43) Pub. Date: Dec. 15, 2011

(54) Animal Collar

(76) Inventor: Philip Kelvin Crisp, Gwent (GB)

(21) Appl. No.: 12/673,353

(22) PCT Filed: Aug. 18, 2008
(86) PCT No.: PCT/EP2008/060785

§ 371 Date: Feb. 12, 2010

(30) Foreign Application Priority Data
Aug. 17, 2007 (GB) 0716105.2
Mar. 6, 2008 (GB) 0804153.5

(51) Int. Cl. A01K 27/00

(52) U.S. Cl. 119/858; 119/856; 119/860

(57) ABSTRACT

A pet safety collar especially for cats comprisesan elongate resilient flexible cord element (11) formed into a coil having a plurality of randomly over-lapping turns, the ends of the element (11) being free. In use, the coils can be opened to allow the collar to be fitted around the neck of an animal, whereupon the collar recovers it shape. In the event that the collar becomes trapped, the coil expands allowing the animal to be freed.

It is well known to fit the collars to domestic animals so that a lead or leash can be attached thereto. Also, collars enable the animals to be provided with identity tags.

Typically, known collars comprise an elongate strap which can be fastened end-to-end round the neck of the animal. A disadvantage of this is that the collar can become tight around the animals neck if the animal grows. Furthermore, the collar can become entangled with objects such as bushes, trees and fences, with the result that the animal may become trapped or strangled. This is a particular problem with cats who have a tendency to climb and force themselves into confined spaces.

Cat collars are known which have an expandable section, which allows the collar to expand when it becomes trapped. Another known cat collar comprises a fastening which releases under a pre-determined load. The aforementioned cat collar suffers from the disadvantage that the degree of expansion is insufficient to prevent strangulation. A disadvantage of the latter is that the fastening can inadvertently release, with the result that the collar becomes lost.

I have now devised an animal collar which alleviates the above-mentioned problems.

In accordance with the present invention, there is provided an animal collar comprising an elongate resilient flexible element formed into a coil comprising a plurality of over-lapping turns, the ends of the element being free.

In use, the coils can be opened to allow the collar to be fitted around the neck of an animal, whereupon the collar recovers it shape. In the event that the collar becomes trapped, the coil expands allowing the animal to be freed.

Preferably the elongate resiliently flexible element comprises nylon or other plastics material which is cheap to manufacture.

Preferably the elongate resiliently flexible element comprises a cord or other filament arranged to coil loosely and randomly around an animal's neck. In order to achieve this, the maximum cross-sectional dimension of the cord or other filament is preferably no more than double the minimum cross-sectional dimension. Preferably the dimensions are substantially equal and preferably the cord or filament is circular in cross-section.

The elongate resiliently flexible element maybe contained within a tubular sleeve, for example, formed of a braided material. The sleeve maybe impregnated or otherwise treated with an insecticide or another compound which treats the animal. In an alternative embodiment, the elongate resiliently flexible element may extend through beads or tubes, which may extend end-to-end of the element.

Preferably the elongate element is provided with means such as beads or eyelets or other formations to which a lead can be attached. Preferably said means comprises at least two formations disposed at spaced apart locations on the elongate element which can be brought and held together when a lead is attached, so as to prevent expansion of the coils and to alleviate the risk that an animal may escape from the lead by pulling on the collar. At least one of the formations may be provided on an end of the elongate element.

Preferably means are provided intermediate opposite ends of the resiliently flexible elongate element for attaching the collar to an identity tag or disc or to another device, such as a bell.

Preferably the coil comprises at least 2 turns and preferably less than 3 turns, so that the collar has to unwind to come off yet is still able to detach readily.

An embodiment of the present invention will now be described by way of example only and with reference to the accompanying drawings, in which:

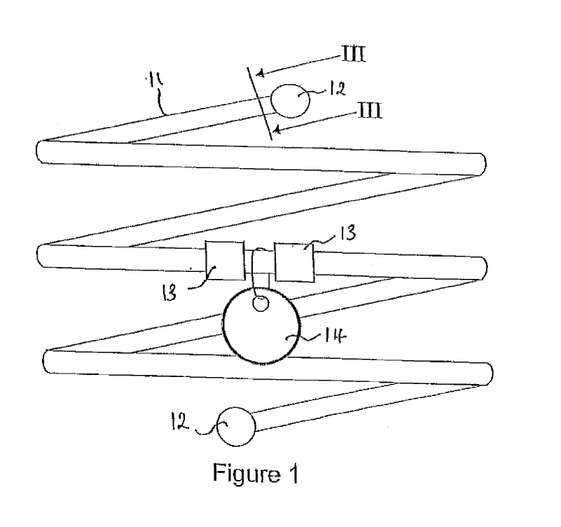

FIG. 1 is a front view of a pet collar in accordance with the present invention;

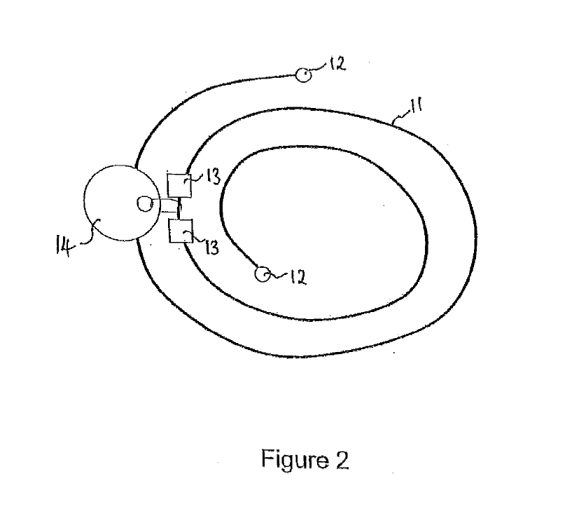

FIG. 2 is a planned view of the collar of FIG. 1; and

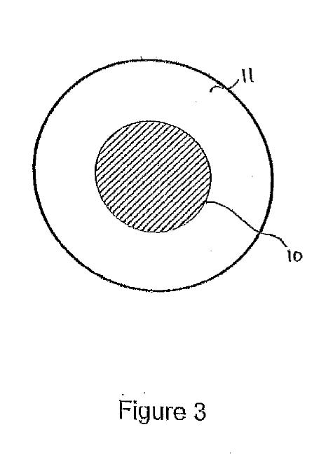

FIG. 3 is a sectional view along the line III-III of FIG. 1.

Referring to the drawings, there is shown a pet collar comprising an elongate resiliently flexible cord 10 of nylon or other plastics material which is formed into a coil comprising at least two overlapping turns. The cord 10 is contained within a braided sleeve 11, which maybe multi-coloured and treated with an insecticide or pharmaceutical product.

The opposite ends of the cord 10 are fitted with beads 12 in order to protect the sharp ends. A pair of beads 13 are fitted intermediate opposite ends of the elongate cord 10, the beads 13 being spaced apart to define a region around which the eyelet of an identity tag 14 maybe fastened. Alternatively, a bell or other device maybe fitted to this region in a similar manner.

In use, the coil is opened to allow it to be passed over the head of an animal, whereupon the coil is allowed to recover its shape so that it is firmly held in-situ. The turns of the coil randomly overlap axially and/or radially of each other with respect to the axis about which the collar is coiled. In the event that the collar becomes trapped, the coils can expand and unwind to allow the animal to free itself.

In an alternative embodiment, one or more of the end beads 12 maybe replaced by eyelets, which allow the collar to be connected to a lead. Preferably, the elongate element is formed into coils which are circular in plan as shown in the drawings. However, it will be appreciated that the coils could be of any suitable shape.

A collar in accordance with the present invention is simple and inexpensive in construction, yet is aesthetically pleasing and alleviates any risk of the animal being injured when the collar becomes trapped.

1. An animal collar comprising an elongate resiliently flexible element formed into a coil comprising a plurality of overlapping turns, the ends of the element being free.

2. An animal collar as claimed in claim 1, in which the elongate resiliently flexible element comprises nylon or other plastics material.

3. An animal collar as claimed in claim 1, in which the elongate resiliently flexible element is contained within a tubular sleeve.

4. An animal collar as claimed in claim 3, in which the sleeve is formed of a braided material.

5. An animal collar as claimed in claim 4, in which the sleeve is impregnated or otherwise treated with an insecticide or another compound which treats the animal.

6. An animal collar as claimed in claim 1, in which the elongate resiliently flexible element extends through beads or tubes.

7. An animal collar claimed in claim 6, in which the beads or tubes extend end-to-end of the element.

8. An animal collar as claimed in claim 2, in which the elongate element is provided with means to which a lead can be attached.

9. An animal collar as claimed in claim 8, in which said lead attachment means comprises at least two formations disposed at spaced apart locations on the elongate element.

10. An animal collar as claimed in claim 9, in which at least one of the formations is provided on an end of the elongate element.

11. An animal collar as claimed in claim 9, in which the formations comprise beads.

12. An animal collar as claimed in claim 9, which the formations comprise eyelets.

13. An animal collar as claimed in claim 1, in which means are provided intermediate opposite ends of the resiliently flexible elongate element for attaching the collar to an identity tag or disc or other device.

14. An animal collar as claimed in claim 1, in which said coil comprises at least 2 turns.

15. An animal collar as claimed in claim 14, in which said coil comprises less than 3 turns.

16. An animal collar as claimed in claim 1, in which the elongate resiliently flexible element comprises a cord or other filament arranged to coil loosely and randomly around an animal's neck.

17. An animal collar as claimed in claim 1, in which the turns of the coil randomly overlap axially and/or radially of each other with respect to the axis about which the elongate resilient flexible element is coiled.

18. An animal collar as claimed in claim 17, in which the maximum cross-sectional dimension of the cord or other filament is no more than double the minimum cross-sectional dimension.

19. An animal collar as claimed in claim 18, in which the two dimensions are substantially equal.

20. (canceled)

21. An animal collar, comprising:
a coil formed form an elongated resiliently flexible element, the coil including at least two freely overlapping turns and two free ends, said coil further including enlarged end elements disposed at the free ends and an attachment loop interposed on said coil between said two free ends for connecting to a bell or tag, said coil further including
two beads disposed thereon in spaced-apart relation and flanking said bell or tag.
